(19) United States
(12) Patent Application Publication
(10) Pub. No.: US 2026/0109874 A1
(43) Pub. Date: Apr. 23, 2026

(54) 3D PRINTABLE POLYPROPYLENE HOMOPOLYMER COMPOSITION, 3D PRINTED PRODUCTS COMPRISING THE SAME, AND METHODS THEREOF

(71) Applicant: Hindustan Petroleum Corporation Limited, Bengaluru (IN)

(72) Inventors: Vinothkumar DHARMAR, Bengaluru (IN); Yogesh Popatrao PATIL, Bengaluru (IN); Bennet CHELLIAHN, Bengaluru (IN); Srinivasa Narasimha SHESHACHALA, Bengaluru (IN)

(73) Assignee: Hindustan Petroleum Corporation Limited, Bengaluru (IN)

(21) Appl. No.: 19/362,099

(22) Filed: Oct. 17, 2025

(30) Foreign Application Priority Data
Oct. 18, 2024 (IN) 202441079382

(51) Int. Cl. C09D 123/12; B29C 64/118; B29K 23/00; B29K 105/00; B29K 509/02; B33Y 10/00; B33Y 40/10; B33Y 70/10; B33Y 80/00; C09D 7/40; C09D 7/61; C09D 7/65

(52) U.S. Cl. CPC C09D 123/12; B29C 64/118; B33Y 70/10; B33Y 80/00; C09D 7/61; C09D 7/65; C09D 7/67; B29K 2023/12; B29K 2023/38; B29K 2105/0005; B29K 2105/0088; B29K 2509/02; B29K 2995/0012; B29K 2995/0082; B33Y 10/00; B33Y 40/10

(57) ABSTRACT

The present invention relates to 3D printable polypropylene (3DPP) homopolymer compositions. Specifically, the present invention relates to a 3DPP homopolymer compositions made by compounding, blending polypropylene with different hydrocarbon resins, fillers, compatibilizers and additives. Also, the invention relates to a method for preparing the 3DPP homopolymer compositions and products 3D printed using the 3DPP homopolymer compositions. The 3D printed products printed using 3DPP homopolymer composition exhibit improved 3D printability, interlayer adhesion, dimensional stability, reduced warpage with very high mechanical properties.

### CROSS-REFERENCE TO RELATED APPLICATION

The present application claims priority to Indian Patent Application number 202441079382, filed on Oct. 18, 2024, the disclosure of which is hereby incorporated by reference in its entirety.

### FIELD OF THE INVENTION

The present invention relates to 3D printable polypropylene (3DPP) homopolymer compositions. Specifically, the present invention relates to a 3DPP homopolymer compositions made by compounding, blending polypropylene with different hydrocarbon resins, fillers, compatibilizers and additives. Also, the invention relates to a method for preparing the 3DPP homopolymer compositions and products 3D printed using the 3DPP homopolymer compositions.

### BACKGROUND OF THE INVENTION

Background description includes information that may be useful in understanding the present invention. It is not an admission that any of the information provided herein is prior art or relevant to the presently claimed invention, or that any publication specifically or implicitly referenced is prior art.

3D Printing, also known as additive manufacturing, is a technology that creates objects, as it offers a plethora of opportunities in the production, design, and performance of novel architectural forms, construction systems, and materials. It is an innovative, faster, and more agile method of product development and production.

The world of 3D printing continues to grow. Acrylonitrile Butadiene Styrene (ABS) and Polylactic Acid (PLA) are commonly used for 3D printer filaments, particularly for non-industrial or high-volume manufacturers. New materials enable expanded functionality of 3D printed pieces and parts. Purchasers look for materials that exhibit extended resistance to chemicals, heat or fatigue, and physical properties such as strength, rigidity, flexibility, softness, color, and appearance.

In general, thermoplastic commodity polyolefin polymers like polyethylene (PE) and polypropylene (PP) have attracted attention due to their availability, low cost with widespread applications in packaging, automotive, and other industries.

Polypropylene is a possible material choice in 3D printing due to its desirable physical, mechanical, chemical, and optical properties for a broad range of applications. Most of the applications are based on PP random copolymer due to its lower crystallinity. But due to its flexible nature, 3D printing manufacturers are facing feeding issues with PP random copolymer-based filaments. Also, the PP random copolymer has poor mechanical properties, lower crystallinity and it is not suitable for industrial applications.

PP homopolymer is well-known for its suitability in industrial applications. However, the main drawback of PP homopolymer is a significant amount of warpage is associated with the 3D printed PP homopolymer parts due to its higher crystallinity which affects geometric accuracy during the product printing.

The Chinese Invention, CN113372647A, disclosed a polypropylene compound with high-precision FDM printing performance and a preparation method thereof. The polypropylene compound is prepared from the following components in parts by mass: 42.5 to 48.3 parts of fiber-grade homo-polypropylene, 10 to 30 parts of high-melt-strength polypropylene, 4 to 12 parts of block co-polypropylene, 5 to 9 parts of cross-linked high-density polyethylene, 0.1 to 0.3 parts of a beta nucleating agent, 2 to 6 parts of chopped carbon fibers, 10 to 20 parts of silicon carbide, 0.1 to 0.3 parts of a main antioxidant and 0.1 to 0.3 parts of an auxiliary antioxidant. The preparation method comprises the following steps of: premixing the fiber-grade homo-polypropylene, the high-melt-strength polypropylene, the block co-polypropylene, the cross-linked high-density polyethylene, the beta nucleating agent, the chopped carbon fibers, the silicon carbide, the main antioxidant and the auxiliary antioxidant, and mixing and granulating by using a parallel co-rotating twin-screw extruder to obtain the polypropylene compound. The polypropylene compound disclosed by the invention has excellent mechanical properties and can be used for FDM printing, and a printed sample has higher precision.

European Patent, EP3526376A1, disclosed a consumable filament for use in an extrusion-based additive manufacturing system comprising a propylene ethylene copolymer having a xylene soluble content ranging from 1 wt. % to 50 wt. % and Melt Flow Rate according to ISO 1133, condition L, i.e. 230° C. and 2.16 kg load ranging from 0.5 to 100 g/10 min.

Chinese Patent CN113423558A, disclosed an extrusion additive manufacturing process comprising the extrusion of a polyethylene composition having a melt flow index (MFI) of at least 0.1 g/10 min., said composition comprising: A) from 1% to 40% by weight of a polyethylene component having a weight average molar mass Mw, as measured by Gel Permeation Chromatography, equal to or higher than 1,000,000 g/mol; B) from 1% to 95% by weight of a polyethylene component having a Mw value from 50,000 to 500,000 g/mol; C) from 1% to 59% by weight of a polyethylene component having a Mw value equal to or lower than 5,000 g/mol.

The Chinese invention, CN108641197A, discloses a polypropylene wire material for 3D printing and a preparation method thereof. The polypropylene wire material is composed of co-polypropylene, low-melting-point homo-polypropylene, inorganic filler, thermoplastic elastomers, a plasticizer and a stabilizer. The polypropylene wire material is low in material crystallinity degree, shrinkage distortion and warping, has good 3D printing effects and printing accuracy, and can reduce cost to a large extent. The preparation method for the polypropylene wire material for 3D printing is simple in technology and lower in production equipment requirement, can achieve large-scale production and popularization, and has a wide market prospect.

In Korean Patent, KR102427613B1 disclosed a polypropylene resin composition for a 3D printer having iso-directional contractibility and high impact properties, a manufacturing method thereof, and a molded product manufactured thereby. More specifically, a polypropylene resin is manufactured by mixing a polypropylene homopolymer with an ethylene-propylene block copolymer, a nucleating agent having beta crystals, a neutralizing agent, and an antioxidant as essential components. Accordingly, mechanical properties, such as iso-directional contractility and high impact, are excellent. Therefore, stackability during 3D printing is improved and excellent shape stability can be obtained after molding. In addition, according to the polypropylene resin composition for a 3D printer of the present invention, since no expensive catalysts or fillers are included, manufacturing costs can be reduced, and also a polypropylene molded product with low specific gravity can be manufactured.

The use of a consumable filament comprising a propylene polymer composition as consumable filament in an extrusion-based additive manufacturing system was disclosed in WO2021069242A1, wherein the propylene polymer composition comprises: A) from 20% to 60% by weight of a propylene copolymer; B) from 5% to 33% by weight of a propylene homo or copolymer wherein the copolymer contains up to 5% by weight of an alpha olefin selected from ethylene, 1-butene, 1-hexene or 1-octene; C) from 2% to 15% by weight of an elastomeric block copolymer comprising styrene; D) from 4% to 32% by weight of an elastomeric ethylene copolymer; E) from 5% to 50% by weight of a glass material as filler; F) from 0.1% to 5% by weight of compatibilizer.

Accordingly, there is a need for preparing 3D polypropylene homopolymer compositions with good mechanical properties and thermal stability compared to PP random copolymer without any warpage.

The present invention satisfies the existing needs, as well as others, and generally overcomes the deficiencies found in the prior art.

### OBJECTS OF THE INVENTION

An object of the present invention is to provide a 3D polypropylene homopolymer composition with good mechanical properties and thermal stability compared to a polypropylene (PP) random copolymer without any warpage.

An object of the present invention is to provide a method for preparing 3D polypropylene homopolymer composition.

Another object of the present invention is to provide 3DPP filaments prepared using 3D polypropylene homopolymer composition.

Yet another object of the present invention is to provide a 3D printed product produced using 3D polypropylene homopolymer composition.

### SUMMARY OF THE INVENTION

This summary is provided to introduce a selection of concepts in a simplified form that is further described below in the detailed description section. This summary is not intended to identify key features or essential features of the claimed subject matter, nor is it intended to be used as an aid in determining the scope of the claimed subject matter.

Aspects of the present invention relate to 3D printable polypropylene (3DPP) homopolymer compositions. Specifically, the present invention relates to a 3DPP homopolymer compositions made by compounding, blending polypropylene with different hydrocarbon resins, fillers, compatibilizers and additives. Also, the invention relates to a method for preparing the 3DPP homopolymer compositions and products 3D printed using the 3DPP homopolymer compositions.

In an aspect, the present invention discloses a 3D printable polypropylene (3DPP) homopolymer composition comprising:
(a) polypropylene in a concentration of 60-99 wt. %;
(b) a hydrocarbon resin in a concentration of 1-20 wt. %;
(c) a particulate filler in a concentration of 1 to 20 wt. %;
(d) a compatibilizer in a concentration of 1-10 wt. %; and
(e) one or more additives.

In an aspect of the present invention, the one or more additives selected from the group consisting of one or more additives are selected from but not limited to an antioxidant, an adhesion-promoting agent, a nucleating agent, an anti-static agent, an anti-blocking agent, a processing aid, a flame-retardant, a plasticizer, a UV absorber, a light stabilizer, a viscosity-modifier, an elastomer, a sliding agent, a sizing agent or compatibilizer, a rubber, a thermoplastic hydrocarbon resin, and any combinations thereof.

In an aspect of the present invention, the 3DPP homopolymer composition has a melt flow index (MFI) in the range of 3 to 30 gm/10 min.

In an aspect of the present invention, the hydrocarbon resin is selected from aliphatic resin of acyclic (C5) or cyclic resin of polycyclopentadiene having a Tg of 45-47° C., an Mw ranging from 780-4681 gm/mol, and softening points of 95-115° C. with a polydispersity index of 1.9-8.8.

In an aspect of the present invention, the hydrocarbon resin is selected from the group consisting of Dicyclopentadiene hydrocarbon resin (DCPD hydrocarbon resin), Commercial aromatic hydrocarbon Resin 1 (C100R), Commercial aromatic hydrocarbon Resin 2 (C115R), and Aliphatic hydrocarbon (1288S).

In an aspect of the present invention, the particulate filler is selected from the group consisting of nano Calcium Carbonate (CaCO₃), nano Talc, and nano silicon dioxide (SiO₂).

In an aspect of the present invention, the compatibilizer is Maleic Anhydride grafted polypropylene with maleic anhydride content of 1-2 wt. %.

In a preferred aspect, the present invention discloses a 3DPP homopolymer composition comprising:
(a) Polypropylene in a concentration of 60 to 99 wt %
(b) Aliphatic Hydrocarbon resin in a concentration of 1 to 20 wt. %;
(c) nano talc or nano calcium carbonate particulate filler in a concentration of 1 to 20 wt. %; and
   (d) Maleic Anhydride grafted polypropylene in a concentration of 1 to 10 wt. %

In another aspect, the present invention discloses a process of producing the 3DPP homopolymer composition comprising the steps of:
(a) compounding of polypropylene (PP) with hydrocarbon resins, fillers, compatibilizers, and optionally, additives by dry-blending in a high-speed mixer to obtain dry blended PP;
(b) reactive extrusion of dry blended PP on a co-rotating twin-screw extruder having screw diameter of 30 mm, L/D of 48/1 having eight heating zones with a temperature profile of 70° C. to 230° C. from feed zone to the die zone, where 230° C. is the die temperature and maintaining feeder screw and extruder screw speeds at 6 and 200 rpm, respectively to obtain 3DPP extrudates;
(c) cooling the 3DPP extrudates by passing through a water bath at room temperature and granulating the same into pellet size of 3 to 5 mm; and
(d) drying the pellets at 80° C. for 3 hr to obtain granules of 3DPP homopolymer composition.

In an aspect of the present invention, the process further comprises the step of drying the granules from step (d) at 80° C. for 3 hr, followed by preparing 3DPP filaments by extruding the dried 3DPP granules in a micro-compounder with a screw speed of 25 and temperature of 230° C. In some aspects, the 3DPP filaments have a diameter of 1.75 mm to 2.85 mm

In yet another aspect, the present invention discloses a 3D printed product printed using the 3DPP homopolymer composition as disclosed herein, wherein the product is selected from a dice, a figurine, a container, a prosthetic, a bottle, functional parts and industrial prototypes, and commercial aesthetic products. In some aspects, the 3D printed product exhibits a crystallization temperature (Tc) of 125° C., flexural modulus of 2100 MPa with an MFI of 20 g/10 min and crystallinity of 20%.

In a further aspect, the present invention discloses a method of 3D printing of a 3D product comprises the steps of: (a) providing a 3D printing feedstock comprising the 3DPP filaments as claimed in claim 10 to a FDM 3D printing apparatus and forming a hot-melt of the feedstock; (b) depositing the hot-melt of the feedstock from the FDM 3D printing apparatus on a substrate by layer-by-layer fashion to obtain a 3D printed product of suitable shape and size. In some aspects, the 3D printing is effected at a temperature of 180 to 250° C.; build plate temperature of 40 to 100° C.; print speed of 20-50 mm/s; infill density of 20-100%; and layer height of 0.15 to 0.3 mm.

Various objects, features, aspects and advantages of the inventive subject matter will become more apparent from the following detailed description of preferred embodiments

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, numbers have been used for quantifying weight percentages, ratios, and so forth, to describe and claim certain embodiments of the invention and are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context requires otherwise, throughout the specification which follow, the word “comprise” and variations thereof, such as, “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

It should also be appreciated that the present disclosure can be implemented in numerous ways, including as a system, a method or a device. In this specification, these implementations, or any other form that the invention may take, may be referred to as processes. In general, the order of the steps of the disclosed processes may be altered within the scope of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements a, b, and c, and a second embodiment comprises elements b and d, then the inventive subject matter is also considered to include other remaining combinations of a, b, c, or d, even if not explicitly disclosed.

While a particular form of the invention has been illustrated and described, it will be apparent that various modifications can be made without departing from the spirit and scope of the invention.

Embodiments of the present invention relate to 3D printable polypropylene (3DPP) homopolymer compositions. Specifically, the present invention relates to a 3DPP homopolymer compositions made by compounding, blending polypropylene with different hydrocarbon resins, fillers, compatibilizers and additives. Also, the invention relates to a method for preparing the 3DPP homopolymer compositions and products 3D printed using the 3DPP homopolymer compositions.

In an embodiment of the present invention, the 3DPP homopolymer composition comprises polypropylene in a concentration of at least about 60 wt. %, at least about 62.5 wt. %, at least about 65 wt. %, at least about 67.5 wt. %, at least about 70 wt. %, at least about 72.5 wt. %, at least about 75 wt. %, at least about 77.5 wt. %, at least about 80 wt. %, at least about 82.5 wt. %, at least about 85 wt. %, at least about 87.5 wt. %, at least about 90 wt. %, at least about 92.5 wt. %, at least about 95 wt. %, at least about 97.5 wt. %, and not more than about 99 wt %. Most preferably, the percentage is at least about 60 to 99 wt. %, with respect to the overall composition.

In an embodiment of the present invention, the polypropylene is selected from but not limited to isotactic, syndiotactic, or atactic polypropylene.

In an embodiment of the present invention, the 3DPP homopolymer composition comprises a hydrocarbon resin in a concentration of at least about 1 wt. %, at least about 2 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 12 wt. %, at least about 14 wt. %, at least about 16 wt. %, at least about 18 wt. %, at least about 20 wt. %, at least about 22 wt. %, at least about 24 wt. %, at least about 26 wt. %, at least about 28 wt. %, at least about 30 wt. %, at least about 32 wt. %, at least about 34 wt. %, at least about 36 wt. %, at least about 38 wt. %, and not more than about 40 wt %. Most preferably, the percentage is at least about 1 to 20 wt. %, with respect to the overall composition.

In an embodiment of the present invention, the hydrocarbon resin is selected from but not limited to aliphatic resin of acyclic (C5) (for example, C5 piperylene and its derivatives, such as cis/trans 1,3-pentadienes, 2-methyl-2-butene, cyclopentene, cyclopentadiene, and dicyclopentadiene) or cyclic resin of polycyclopentadiene having a Tg of 45-47° C., an Mw ranging from 780-4681 gm/mol, and softening points of 95-115° C. with a polydispersity index of 1.9-8.8. In preferred embodiments, the hydrocarbon resin is selected from the group consisting of Dicyclopentadiene hydrocarbon resin (DCPD hydrocarbon resin), Commercial Aromatic Hydrocarbon resin 1 (C100R), Commercial hydrocarbon Resin 2 (C115R), and Aliphatic Hydrocarbon resin (1288S)

In an embodiment of the present invention, the 3DPP homopolymer composition comprises a particulate filler in a concentration of at least about 0.25 wt. %, at least about 0.5 wt. %, at least about 0.75 wt. %, at least about 1.0 wt. %, at least about 1.5 wt. %, at least about 2.0 wt. %, at least about 2.5 wt. %, at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 12.5 wt. %, at least about 15 wt. %, at least about 17.5 wt. %, at least about 20 wt. %, at least about 22.5 wt. %, at least about 25 wt. %, at least about 27.5 wt. %, at least about 30 wt. %, at least about 32.5 wt. %, at least about 35 wt. %, at least about 37.5 wt. %, and not more than about 40 wt %. Most preferably, the percentage is at least about 1 to 20 wt. %, with respect to the overall composition.

In an embodiment of the present invention, the organic or inorganic fillers include but are not limited to nanoparticles or microparticles of graphene, talc, marble dust, cement dust, rice husk, clay, carbon black, feldspar, silica, glass, fumed silica, silicate, calcium silicate, silicic acid powder, glass microspheres, mica, metal oxide particles and nanoparticles such as magnesium oxide, antimony oxide, zinc oxide, barium sulfate, wollastonite, alumina, aluminum silicate, a titanium oxide, calcium carbonate, a polyhedral oligomeric silsesquioxane, and any combinations thereof. Preferably, nano Calcium Carbonate (CaCO₃), nano Talc, nano silicon dioxide (SiO₂), and combinations thereof.

In an embodiment of the present invention, the 3DPP homopolymer composition comprises a compatibilizer in a concentration of at least about 0.1 wt. %, at least about 0.2 wt. %, at least about 0.3 wt. %, at least about 0.4 wt. %, at least about 0.5 wt. %, at least about 0.6 wt. %, at least about 0.7 wt. %, at least about 0.8 wt. %, at least about 0.9 wt. %, at least about 1.0 wt. %, at least about 1.1 wt. %, at least about 1.2 wt. %, at least about 1.3 wt. %, at least about 1.4 wt. %, at least about 1.5 wt. %, at least about 2.0 wt. %, at least about 2.5 wt. %, at least about 3.0 wt. %, at least about 3.5 wt. %, at least about 4.0 wt. %, at least about 4.5 wt. %, at least about 5.0 wt. %, at least about 6 wt. %, at least about 7 wt. %, at least about 8.0 wt. %, at least about 9.0 wt. %, and not more than about 10.0 wt %. Most preferably, the percentage is at least about 1 to 10 wt. %, with respect to the overall composition.

In an embodiment of the present invention, the compatibilizer is selected from but not limited to Maleic Anhydride grafted polypropylene with maleic anhydride content of 1-2 wt. %, Acrylics Acid grafted Polypropylene with acrylic acid content of up to 1-10 wt %, Styrene Maleic Anhydride copolymer with Maleic anhydride content of 1-5 wt %, Trimethylolpropane Triacrylate grafted Polyproylene with Trimethylolpropane Triacrylate content of 1 to 10 wt %, Meth methacrylate grafted Polypropylene with Methyl Methacrylate content of 1 to 10 wt % and like.

In an embodiment of the present invention, the 3DPP homopolymer composition comprises one or more additives, when present, in a concentration of at least about 0.1 wt. %, at least about 0.2 wt. %, at least about 0.3 wt. %, at least about 0.4 wt. %, at least about 0.5 wt. %, at least about 0.6 wt. %, at least about 0.7 wt. %, at least about 0.8 wt. %, at least about 0.9 wt. %, at least about 1.0 wt. %, at least about 1.1 wt. %, at least about 1.2 wt. %, at least about 1.3 wt. %, at least about 1.4 wt. %, at least about 1.5 wt. %, at least about 2.0 wt. %, at least about 2.5 wt. %, at least about 3.0 wt. %, at least about 3.5 wt. %, at least about 4.0 wt. %, at least about 4.5 wt. %, at least about 5.0 wt. %, at least about 6 wt. %, at least about 7 wt. %, at least about 8.0 wt. %, at least about 9.0 wt. %, and not more than about 10.0 wt %. Most preferably, the percentage is at least about 0.1 to 1 wt. %, with respect to the overall composition.

In an embodiment of the present invention, the one or more additives are selected from but not limited to an antioxidant, an adhesion-promoting agent, a nucleating agent, an anti-static agent, an anti-blocking agent, a processing aid, a flame-retardant, a plasticizer, a UV absorber, a light stabilizer, a viscosity-modifier, an elastomer, a sliding agent, a sizing agent or compatibilizer, a rubber, a thermoplastic hydrocarbon resin, and any combinations thereof.

In a preferred embodiment, the present invention provides a 3D printable polypropylene (3DPP) homopolymer composition comprising:
(a) polypropylene in a concentration of 60-99 wt. %;
(b) a hydrocarbon resin in a concentration of 1-20 wt. %;
(c) a particulate filler in a concentration of 1 to 20 wt. %;
(d) a compatibilizer in a concentration of 1-10 wt. %; and
(e) one or more additives.

In an embodiment of the present invention, the 3DPP homopolymer composition has a melt flow index (MFI) in the range of 3 to 30 gm/10 min, measured according to ASTM D 1238.

In a most preferred embodiment, the present invention provides a 3D printable polypropylene (3DPP) homopolymer composition comprising:
a) Polypropylene in a concentration of 60 to 99 wt. %;
(b) Aliphatic Hydrocarbon resin in a concentration of 1 to 20 wt. %;
(c) nano talc or nano calcium carbonate particulate filler in a concentration of 1 to 20 wt. %; and
(d) Maleic Anhydride grafted polypropylene in a concentration of 1 to 10 wt. %

In another embodiment, the present invention provides process of producing the 3DPP homopolymer composition as disclosed herein comprises the steps of:
(e) compounding of polypropylene (PP) with hydrocarbon resins, fillers, compatibilizers, and optionally, additives by dry-blending in a high-speed mixer to obtain dry blended PP;
(f) reactive extrusion of dry blended PP on a co-rotating twin-screw extruder having screw diameter of 30 mm, L/D of 48/1 having eight heating zones with a temperature profile of 70° C. to 230° C. from feed zone to the die zone, where 230° C. is the die temperature and maintaining feeder screw and extruder screw speeds at 6 and 200 rpm, respectively to obtain 3DPP extrudates;
(g) cooling the 3DPP extrudates by passing through a water bath at room temperature and granulating the same into pellet size of 3 to 5 mm; and
(h) drying the pellets at 80° C. for 3 hr to obtain granules of 3DPP homopolymer composition.

In an embodiment of the present invention, the process further comprises the step of drying the granules from step (d) at 80° C. for 3 hr, followed by preparing 3DPP filaments by extruding the dried 3DPP granules in a micro-compounder with a screw speed of 25 and temperature of 230° C.

In an embodiment of the present invention, the 3DPP homopolymer composition be supplied as a feedstock for 3D Printing, in various forms or shapes, such as filaments, rods, strands, powder, pellets, a distribution of powders or pellets, or granules. Preferably, 3DPP filaments having a diameter of 1 mm to 5 mm. Preferably, the 3DPP filaments having a diameter of 1.75 mm to 2.85 mm. In some embodiments, the 3DPP filaments may be wound and may be connected to a 3D printer (fused deposition modeling (FDM) 3D printer) for printing.

In an embodiment of the present invention, the 3DPP filaments have improved 3D printability, interlayer adhesion, dimensional stability, reduced warpage with very high mechanical properties

In yet another embodiment, the present invention provides a method of 3D printing of a product using 3DPP homopolymer composition as described herein comprises the steps of: (a) providing a 3D printing feedstock comprising the 3DPP filaments having a diameter of 1.75 mm to 2.85 mm prepared using the 3DPP homopolymer composition as described herein to a FDM 3D printing apparatus and forming a hot-melt of the feedstock; (b) depositing the hot-melt of the feedstock from the FDM 3D printing apparatus on a substrate by layer-by-layer fashion to obtain a 3D printed product of suitable shape and size.

In an embodiment of the present invention, the 3D printed product printed using FDM 3D printer with printing temperature of 180 to 250° C., preferably 215° C.; build plate temperature of 40 to 100° C., preferably 60° C.; print speed of 20-50 mm/s; infill density of 20-100%; and layer height of 0.1-0.3 mm.

In an embodiment of the present invention, the 3D printed product is selected from nut not limited to a dice, a figurine, a container, a prosthetic, or a bottle, functional parts and industrial prototypes, and commercial aesthetic products.

In an embodiment of the present invention, the 3D printed product exhibit improved 3D printability, interlayer adhesion, dimensional stability, reduced warpage with very high mechanical properties.

In an embodiment of the present invention, the FDM 3D Printing feedstock comprising the 3DPP homopolymer composition as described herein may be prepared as a product in the form of an extruded article, wherein the extruded article can exhibit a reduced warpage.

In an embodiment, the 3DPP homopolymer composition of the present invention maybe used in any manner known to a person skilled in the art.

### EXAMPLES

The present invention is further explained in the form of following examples. However, it is to be understood that the following examples are merely illustrative and are not to be taken as limitations upon the scope of the invention.

### Materials and Characterization

Materials: Polypropylene homopolymer (Trade name: M12RR, MFI: 12 g/10 min, Density: 0.9 g/cm3), was obtained from HPCL-Mittal Energy Limited (HMEL), Punjab, India. Commercial Aromatic Hydrocarbon resin 1 (C100R), Tg—45° C., Mw—780, Softening Point: 100° C., Colour Gardner: 1.3, Mn—410, PDI—1.9) and Commercial Aromatic Hydrocarbon resin 2 (C115R), Tg—45° C., Mw—1150, Softening Point: 115° C., Gardner: 1.1, Mn—550, PDI—2,1) was purchased. Aliphatic Hydrocarbon resin (1288S) Tg—47° C., Mw—3019, softening point: 95° C., Gardner: 3.12, Mn—1310, PDI—2.3) was purchased. CaCO₃ (1-10 Micron) and Talc (1-10 Micron) were purchased. Maleic Anhydride grafted Polypropylene, MA-g-PP (1% Grafting Index) was purchased from. DCPD hydrocarbon resin (DCPD) was synthesized inhouse in HPCL Green R&D Centre (HPGRDC), Bangalore having Tg—46° C., Mw—4681 g/mol, Softening Point—101° C., Colour (Gardner)—6.08, Mn 530 g/mol, PDI (Mw/Mn)—8.8. All other chemicals were used as obtained without any further modification or purification.

### Melt Flow Index (MFI)

MFI (g/10 min) of HP-3DPP compositions & pristine PP was determined using a melt flow indexer (Model CEAST MF20, Instron, UK) at 230° C. utilizing a load of 2.16 kg according to ASTM D1238.

### Differential Scanning Calorimetry (DSC)

Differential scanning calorimetry (DSC Discovery 2500, TA Instruments Ltd, USA) of various PP compositions was performed as per ASTM D3418. Melting Temperature (Tm), Crystallization Temperature (Tc) and Percent Crystallinity (% C) was measured.

### Mechanical Properties

Tensile properties were measured using a universal testing machine (Model 50 ST, Tinius Olsen, UK), according to ASTM-D638. Tensile Strength (TS-MPa), Tensile Modulus (TM-MPa), Impact Strength (IS-J/m) were measured

### Preparation of HP-3D Polypropylene Compositions

The polypropylene homopolymer, hydrocarbon resins, fillers, maleic anhydride grafted PP was physically dry blended using high speed mixer, prior to extrusion. Reactive extrusion of above dry blended PP compositions was performed on a co-rotating twin-screw extruder (Flytech Engineering Chennai, India) having screw diameter of 30 mm, L/D of 48/1 having eight heating zones. Temperature profile in extruder was maintained as 70° C. to 230° C. from feed zone to the die zone, where 230° C. is the die temperature. Feeder screw and extruder screw speeds were set at 6 and 200 rpm, respectively. The die diameter of the extruder was 4 mm. The Concentration of hydrocarbon resin was varied from 1 to 20 weight percentage. Concentration of filler was varied from 1 to 20 weight percentage. Maleic Anhydride grafted PP concentration was fixed as 1-10 wt. % weight percentage. The extrudates were cooled by passing through a water bath (at 25° C.) and granulated into pellet size of 3 to 5 mm. All these granules were dried at 80° C. for 3 hr. and molded into ASTM test specimens and 3D test specimens and evaluated for their MFI, Thermal and mechanical properties.

Example 1 gives the details of blending of polypropylene homopolymer (PPHP) with different concentrations of commercial aromatic hydrocarbon resin 1 (C100R) (10-20 wt. %), its extrusion and pelletization as described above. For comparison PPHP and Ultimaker PP were also extruded under identical conditions as reference. HP-3D PP compositions of PPHP with commercial aromatic hydrocarbon resin 1 (C100R) are given in Table 1.

### Example 2

Polypropylene homopolymer (PPHP) was blended with different concentrations of commercial aromatic hydrocarbon resin 2 (C115R) (10-20 wt. %), then extruded and pelletized as done in Example 1. HP-3D PP compositions of PPHP with commercial aromatic hydrocarbon resin 2 (C115R) are given in Table 1.

### Example 3

Polypropylene homopolymer (PPHP) was blended with different concentrations of aliphatic hydrocarbon resin (1288S) (10-20 wt. %), then extruded and pelletized as done in Example 1. HP-3D PP compositions of PPHP with aliphatic hydrocarbon resin (1288S) are given in Table 1.

### Example 4

Polypropylene homopolymer (PPHP) was blended with different concentrations of in house synthesized Dicyclopentadiene resin (HP-DCPD hydrocarbon resin (10-20 wt. %), then extruded and pelletized as done in Example 1. HP-3D PP compositions of PPHP with HP-DCPD hydrocarbon resin are given in Table 1.

TABLE 1
HP-3DPP Compositions of Polypropylene homopolymer
with different Hydrocarbons resins

| | | | Commercial | Commercial | | |
|---|---|---|---|---|---|---|
| | | | Aromatic | Aromatic | Aliphatic | |
| | | | hydrocarbon | hydrocarbon | Hydrocarbon | HP-DCPD |
| | | | Resin-1 | Resin-2 | Resin | Hydrocarbon |
| Sr. | HP-3DPP | PP | (C100R) | (C115R) | (1288S) | Resin |
| No. | Compositions | (gm) | (gm) | (gm) | (gm) | (gm) |
| 1 | PP | 100 | 0 | 0 | 0 | 0 |
| 2 | Ultimaker PP | 100 | 0 | 0 | 0 | 0 |
| 3 | Composition - 1 | 90 | 10 | 0 | 0 | 0 |
| 4 | Composition - 2 | 80 | 20 | 0 | 0 | 0 |
| 5 | Composition - 3 | 90 | 0 | 10 | 0 | 0 |
| 6 | Composition - 4 | 80 | 0 | 20 | 0 | 0 |
| 7 | Composition - 5 | 90 | 0 | 0 | 10 | 0 |
| 8 | Composition - 6 | 80 | 0 | 0 | 20 | 0 |
| 9 | Composition - 7 | 90 | 0 | 0 | 0 | 10 |
| 10 | Composition - 8 | 80 | 0 | 0 | 0 | 20 |

In order to improve the dimensional stability and reduce the warpage of the printed materials, to give better performance compared to commercial 3DPP filaments, various fillers were added to above 3DPP compositions of PP/hydrocarbon resin (Aliphatic) along with/without using compatibilizer (PP-g-MA). Various compositions made using Talc and CaCO₃ are given in Table 2

### Example 5

Polypropylene homopolymer (PPHP) was dry blended with different concentrations of Aliphatic hydrocarbon resin (10-20 wt. %), Talc (2.5-5 wt. %) and 3-5 wt. % of compatibilizer (MA-g-PP). The dry blended material was melt mixed, extruded in Twin Screw Extruder and pelletized into granules as given in Example 1. All these HP-3D PP compositions are given in Table 2.

### Example 6

Polypropylene homopolymer (PPHP) was dry blended with different concentrations of Aliphatic hydrocarbon resin (10-20 wt. %), Calcium Carbonate (2.5-5 wt. %) and 3-5 wt. % of compatibilizer (MA-g-PP). The dry blended material was melt mixed, extruded in Twin Screw Extruder and pelletized into granules as given in Example 1. All these HP-3D PP compositions are given in Table 2.

TABLE 2
HP-3DPP Compositions of PPHP with Hydrocarbon
Resin and Different Fillers

| | | | Aliphatic | | | |
|---|---|---|---|---|---|---|
| | | | Hydrocarbon | | | |
| | | | Resin | | | MA-g- |
| Sr. | HP-3DPP | PP | (1288S) | Talc | CaCO₃ | PP |
| No. | Compositions | (%) | (%) | (%) | (%) | (%) |
| 1 | Pristine PP | 100 | 0 | 0 | 0 | 0 |
| 2 | Composition - 5 | 90 | 10 | 0 | 0 | 0 |
| 3 | 3DPPT-1 | 87.5 | 10 | 2.5 | 0 | 0 |
| 4 | 3DPPT-2 | 85 | 10 | 5 | 0 | 0 |
| 5 | 3DPPT-3 | 87.5 | 10 | 2.5 | 0 | 3 |
| 6 | 3DPPT-4 | 85 | 10 | 5 | 0 | 3 |
| 7 | 3DPPC-1 | 87.5 | 10 | 0 | 2.5 | 0 |
| 8 | 3DPPC-2 | 85 | 10 | 0 | 5 | 0 |
| 9 | 3DPPC-3 | 87.5 | 10 | 0 | 2.5 | 3 |
| 10 | 3DPPC-4 | 85 | 10 | 0 | 5 | 3 |

### Preparation of HP 3DPP Filaments:

All the above obtained extruded pellets were dried in an oven at 80° C. for about 1 h prior to preparing the 3D printable filaments. 3D PP Filaments were prepared using micro compounder (Thermo Scientific HAAKE minilab 3, Thermo Fisher Scientific India Pvt Ltd, India) with fabricated die of 2.85 mm. Temperature profile in micro compounder was maintained at 230° C. Micro compounder screw speeds were set at 25 and conveyor belt speed were set at 3, for filament fabrication.

The 3DPP filaments were also prepared using Single screw extruder (Screw diameter 35 mm, L/D 28:1) at commercial scale for both 1.75 mm and 2.85 mm diameter with a tolerance of 0.05 mm.

### 3D Printing of Finished Products and Prototypes:

The test specimens, prototype & finished products of HP-3D PP compositions were printed using 3D printer (Ultimaker S5, Ultimaker) with printing temperature—215° C., build plate temperature—60° C., print speed—30 mm/s, infill density—100%, infill pattern—line, layer height—0.2 mm. All the test specimens printed were conditioned at 23±2° C. and 50±5% RH for 40 h prior to testing, as per ASTM D618. MFI, Thermal, Mechanical properties for all the above 3DPP formulations were evaluated as per ASTM test methods and the results are given in Tables 3-5.

TABLE 3
MFI/Thermo-Mechanical Properties of HP-3DPP Compositions
of PP with different Hydrocarbon Resins

| | | Melt | | | | | |
|---|---|---|---|---|---|---|---|
| | | Flow | Melting | Crystallization | | | |
| | | Index | Temp | Temp | | Tensile | Percentage |
| Sr. | HP-3DPP | (gm/10 | (Tm) | (Tc) | Crystallinity | Strength | Elongation |
| No | Compositions | min) | (° C.) | (° C.) | (%) | (MPa) | at Yield |
| 1 | PP | 12 | 166 | 115 | 45 | 30 | 16 |
| 2 | Ultimaker PP | 21 | 132 | 93 | 21 | 13 | 30 |
| 3 | Composition - 1 | 16 | 163 | 116 | 43 | 29 | 15 |
| 4 | Composition - 2 | 22 | 162 | 114 | 43 | 30 | 8 |
| 5 | Composition - 3 | 15 | 165 | 117 | 45 | 29 | 12 |
| 6 | Composition - 4 | 22 | 161 | 116 | 42 | 30 | 6 |
| 7 | Composition - 5 | 21 | 164 | 114 | 42 | 31 | 13 |
| 8 | Composition - 6 | 23 | 163 | 115 | 41 | 32 | 13 |
| 9 | Composition - 7 | 23 | 160 | 112 | 44 | 34 | 13 |
| 10 | Composition - 8 | 23 | 163 | 114 | 43 | 33 | 13 |

Addition of Hydrocarbon Resins to PP increased MFI to 22-23 gm/10 min similar to MFI obtained for commercial Ultimaker 3D PP. Both commercial aromatic hydrocarbon resins (C100R & C115R) released little volatile compounds (VOC) during melt processing and 3D printing leading to defects on filaments such as rough surface and air bubbles. These defected filaments will lead to poor quality especially interlayer adhesion while 3D printing 3D products. In house made DCPD hydrocarbon resin gave better filaments without VOCs. Addition of 10 to 20 wt. % aliphatic hydrocarbon resin blended PP composition are found suitable for 3D printing applications which showed low warpage and better dimensional stability compare to commercial 3DPP filaments in printed parts.

TABLE 4
MFI and Thermal Properties of 3DPP compositions of
PP with Hydrocarbon Resin and different Fillers

| | | | | Crystal- | |
|---|---|---|---|---|---|
| | | Melt Flow | Melting | lization | Crystal- |
| Sr. | HP-3DPP | Index (MFI) | Temp (Tm) | Temp (Tc) | linity |
| No | Compositions | (gm/10 min) | (° C.) | (° C.) | (%) |
| 1 | Pristine PP | 12 | 166 | 115 | 44 |
| 2 | Composition - 5 | 21 | 164 | 114 | 42 |
| 3 | 3DPPT-1 | 20 | 162 | 125 | 46 |
| 4 | 3DPPT-2 | 21 | 163 | 125 | 45 |
| 5 | 3DPPT-3 | 22 | 162 | 123 | 46 |
| 6 | 3DPPT-4 | 22 | 162 | 124 | 45 |
| 7 | 3DPPC-1 | 21 | 163 | 120 | 46 |
| 8 | 3DPPC-2 | 19 | 163 | 116 | 25 |
| 9 | 3DPPC-3 | 22 | 164 | 114 | 19 |
| 10 | 3DPPC-4 | 22 | 164 | 114 | 20 |

TABLE 5
Mechanical Properties of HP-3DPP compositions of
PP with Hydrocarbon Resin and different Fillers

| | | Tensile | | Flexural | Flexural | Impact | |
|---|---|---|---|---|---|---|---|
| Sr. | HP-3DPP | Strength | % Strain | Modulus | Strength | Strength | Shore D |
| No. | Compositions | (MPa) | at Yield | (MPa) | (MPa) | (J/m) | hardness |
| 1 | Pristine PP | 33 | 18 | 1290 | 40 | 23 | 70 |
| 2 | Composition - 5 | 33 | 17 | 1690 | 48 | 9 | 72 |
| 3 | 3DPPT-1 | 34 | 15 | 1860 | 50 | 9 | 73 |
| 4 | 3DPPT-2 | 34 | 14 | 2100 | 51 | 8 | 73 |
| 5 | 3DPPT-3 | 34 | 15 | 1780 | 48 | 8 | 73 |
| 6 | 3DPPT-4 | 35 | 14 | 1890 | 47 | 8 | 73 |
| 7 | 3DPPC-1 | 32 | 15 | 1550 | 44 | 17 | 72 |
| 8 | 3DPPC-2 | 32 | 15 | 1640 | 45 | 9 | 73 |
| 9 | 3DPPC-3 | 32 | 15 | 1520 | 42 | 8 | 73 |
| 10 | 3DPPC-4 | 31 | 15 | 1600 | 43 | 8 | 73 |

Addition of Talc and CaCO₃ along with hydrocarbon resins increased MFI up to 22 gm/10 min with increase in crystalline temperature (Tc) increased to 120-125° C. compared to reference sample 114° C. whereas percent crystallinity decreased from 46% to 19% especially with CaCO₃ in presence of compatibilizer. The percent crystallinity of 19% obtained using fillers is similar to crystallinity obtained for commercial 3D PP samples. The lower percentage crystallinity will lead to lower warpage and better dimensional stability. Addition of Talc & CaCO₃ increased flexural modulus from 1290 MPa to 2100 MPa & 1640 MPa. Flexural strength increased to 48-51 MPa from 40 MPa.

Comparison of Commercial 3D PP Filament Grades with HP-3DPP Filaments

The percentage crystallinity of HP-3DPP compositions made with PP/hydrocarbon resins/CaCO₃ compositions is comparable with commercial 3DPP materials. These materials, HP-3DPP filaments and products made out of these compositions showed superior Thermo-Mechanical properties, dimensional stability, reduced warpage compared to commercial filaments as given in Table 6.

TABLE 6
Comparison of HP-3DPP grade with commercial 3DPP grade

| | Thermo-Mechanical | Ultimaker PP | |
|---|---|---|---|
| Sr. No. | Properties | (Commercial grade) | HP-3DPP |
| 1 | MFI (230° C./2.16 Kg) | 20 | 20 |
| | (gm/10 min) | | |
| 2 | Tensile Strength (MPa) | 13 | 31 |
| 3 | Flexural Modulus (MPa) | 350 | 2100 |
| 4 | Melting Temperature(° C.) | 132 | 164 |
| 5 | Crystalline Temperature (° C.) | 93 | 125 |
| 6 | Crystallinity (%) | 21 | 20 |

The foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Advantages of the Present Invention

The 3DPP homopolymer composition for Fused Deposition Modelling (FDM) with improved interlayer adhesion and reduced warpage combines the benefits of excellent interlayer adhesion with minimal warpage and shrinkage, results in superior 3D printing. Compared to the Polypropylene random copolymer filaments, the 3DPP homopolymer composition demonstrates a twofold increase in thermo-mechanical properties.

We claim:

1. A 3D printable polypropylene (3DPP) homopolymer composition comprising:
(a) polypropylene in a concentration of 60-99 wt %;
(b) a hydrocarbon resin in a concentration of 1-20 wt %;
(c) a particulate filler in a concentration of 1-20 wt %;
(d) a compatibilizer in a concentration of 1-10 wt %; and
(e) one or more additives.

2. The 3DPP homopolymer composition as claimed in claim 1, wherein the one or more additives selected from the group consisting of one or more additives are selected from but not limited to an antioxidant, an adhesion-promoting agent, a nucleating agent, an anti-static agent, an anti-blocking agent, a processing aid, a flame-retardant, a plasticizer, a UV absorber, a light stabilizer, a viscosity-modifier, an elastomer, a sliding agent, a sizing agent or compatibilizer, a rubber, a thermoplastic hydrocarbon resin, and any combinations thereof.

3. The 3DPP homopolymer composition as claimed in claim 1 has a melt flow index (MFI) in the range of 3 to 30 gm/10 min.

4. The 3DPP homopolymer composition as claimed in claim 1, wherein the hydrocarbon resin is selected from aliphatic resin of acyclic (C5) or cyclic resin of polycyclopentadiene having a Tg of 45-47° C., an Mw ranging from 780-4681 gm/mol, and softening points of 95-115° C. with a polydispersity index of 1.9-8.8.

5. The 3DPP homopolymer composition as claimed in claim 4, wherein the hydrocarbon resin is selected from the group consisting of Dicyclopentadiene hydrocarbon resin (DCPD hydrocarbon resin), commercial aromatic hydrocarbon resins (C100R and C115R), and aliphatic resins (1288S).

6. The 3DPP homopolymer composition as claimed in claim 1, wherein the particulate filler is selected from the group consisting of nano Calcium Carbonate (CaCO₃), nano Talc, and nano silicon dioxide (SiO₂).

7. The 3DPP homopolymer composition as claimed in claim 1, wherein the compatibilizer is selected from the group consisting of Maleic Anhydride grafted polypropylene with maleic anhydride content of 1-2 wt. %, Acrylics Acid grafted Polypropylene with acrylic acid content of up to 1-10 wt %, Styrene Maleic Anhydride copolymer with Maleic anhydride content of 1-5 wt %, Trimethylolpropane Triacrylate grafted Polyproylene with Trimethylolpropane Triacrylate content of 1 to 10 wt %, Meth methacrylate grafted Polypropylene with Methyl Methacrylate content of 1 to 10 wt %.

8. A 3DPP homopolymer composition comprising:
(a) Polypropylene in a concentration of 60 to 99 wt %;
(b) Aliphatic Hydrocarbon resin in a concentration of 1 to 20 wt %;
(c) nano talc or nano calcium carbonate particulate filler in a concentration of 1 to 20 wt %; and
(d) Maleic Anhydride grafted polypropylene in a concentration of 1 to 10 wt %.

9. A process of producing the 3DPP homopolymer composition as claimed in claim 1 comprising:
(a) compounding of polypropylene (PP) with hydrocarbon resins, fillers, compatibilizers, and optionally, additives by dry-blending in a high-speed mixer to obtain dry blended PP;
(b) reactive extrusion of dry blended PP on a co-rotating twin-screw extruder having screw diameter of 30 mm, L/D of 48/1 having eight heating zones with a temperature profile of 70° C. to 230° C. from feed zone to the die zone, where 230° C. is the die temperature and maintaining feeder screw and extruder screw speeds at 6 and 200 rpm, respectively to obtain 3DPP extrudates;
(c) cooling the 3DPP extrudates by passing through a water bath at room temperature and granulating the same into pellet size of 3 to 5 mm; and
(d) drying the pellets at 80° C. for 3 hr to obtain granules of 3DPP homopolymer composition.

10. The process as claimed in claim 9 further comprises the step of drying the granules from step (d) at 80° C. for 3 hr, followed by preparing 3DPP filaments by extruding the dried 3DPP granules in a micro-compounder with a screw speed of 25 and temperature of 230° C.

11. The process as claimed in claim 10, wherein the 3DPP filaments have a diameter of 1.75 mm to 2.85 mm.

12. A 3D printed product printed using the 3DPP homopolymer composition as claimed in claim 1, wherein the product is selected from a dice, a figurine, a container, a prosthetic, a bottle, functional parts and industrial prototypes, and commercial aesthetic products.

13. The product as claimed in claim 11 exhibits a crystallization temperature (Tc) of 125° C., flexural modulus of 2100 MPa with an MFI of 20 g/10 min and crystallinity of 20%.

14. A method of 3D printing of a 3D product comprising: (a) providing a 3D printing feedstock comprising the 3DPP filaments as claimed in claim 10 to a FDM 3D printing apparatus and forming a hot-melt of the feedstock; (b) depositing the hot-melt of the feedstock from the FDM 3D printing apparatus on a substrate by layer-by-layer fashion to obtain a 3D printed product of suitable shape and size.

15. The method as claimed in claim 14, wherein the 3D printing is effected at a temperature of 180 to 250° C.; build plate temperature of 40-100° C.; print speed of 20 to 50 mm/s; infill density of 20 to 100%; and layer height of 0.1 to 0.3 mm.
